(19) United States
(12) Patent Application Publication
(10) Pub. No.: US 2014/0291445 A1
(43) Pub. Date: Oct. 2, 2014

(54) SPACE SAVING AIRCRAFT WHEELCHAIR ACCESSIBLE LAVATORY

(71) Applicant: B/E Aerospace, Inc., Wellington, FL (US)

(72) Inventors: Robert Klaus Brauer, Seattle, WA (US); Carrie R. McEwan, Seattle, WA (US); Hany A.-H. Elkordy, Sammamish, WA (US); Barry J. Erickson, Seattle, WA (US)

(73) Assignee: B/E Aerospace, Inc., Wellington, FL (US)

(21) Appl. No.: 14/225,123

(22) Filed: Mar. 25, 2014

Related U.S. Application Data
(60) Provisional application No. 61/805,914, filed on Mar. 27, 2013.

(51) Int. Cl. B64D 11/02; B64D 11/06; B64D 11/00

(52) U.S. Cl. CPC B64D 11/02; B64D 11/00; B64D 11/06
USPC 244/118.5

(57) ABSTRACT

A space saving aircraft wheelchair accessible lavatory for a passenger aircraft interior cabin includes an exterior wall having a first portion spaced apart from an emergency exit path a sufficient distance to define a space for a crew member to assist passengers exiting the airplane in an emergency. A second portion of the exterior wall is offset relative to the first portion of the exterior wall, such as to provide a space within the lavatory for the temporary placement of a wheelchair, or for installation of an amenity. An attendant seat is also provided adjacent to the exterior wall and the emergency exit path.

### CROSS-REFERENCES TO RELATED APPLICATIONS

This application is based upon and claims priority from U.S. Provisional Application No. 61/805,914, filed Mar. 27, 2013, incorporated by reference in its entirety.

### BACKGROUND OF THE INVENTION

The present invention relates generally to aircraft cabin enclosures such as an aircraft closet or an aircraft lavatory, and more particularly relates to an envelope for a wheelchair-accessible lavatory, that provides for more efficient space utilization in the aircraft by employing a exterior wall with a first part offset relative to a second part into the lavatory volume to provide a portion of the space external to the lavatory required for crew members to assist passengers exiting the airplane in the event of an emergency evacuation of the airplane.

For ease of manufacture and ease of installation adjacent other interior structures, aircraft lavatories of the prior art typically have flat walls on all sides facing the aircraft interior as depicted by the lavatory envelope depicted in FIG. 3 and FIG. 4. Aircraft lavatories are typically located adjacent a doorway emergency exit path. A variety of techniques have been employed for transferring a mobility-impaired passenger between an aisle wheelchair and a toilet. A 90° transfer in which the aisle wheelchair is positioned at a 90° angle to the toilet and an assistant lifts the mobility-impaired passenger and rotates the passenger onto the toilet, and vice versa, has been found to reduce the risk of injury to the assistant and is, therefore, a favored method for assisted transfers. An aisle wheelchair position for the 90° transfer is illustrated in FIG. 3. A lateral transfer, in which a mobility-impaired passenger slides sideways from wheelchair to toilet and vice versa can be favored for an unassisted transfer in which the mobility-impaired passenger prefers to make the transfer unaided and has the upper body strength to do so. The aisle wheelchair position for the lateral transfer is shown in FIG. 4.

To provide a space for a crew member to stand by an emergency exit door for the purpose assisting passengers during an emergency evacuation of an aircraft, airworthiness authorities require that a 12-inch by 20-inch “assist space” be provided adjacent the aircraft exit doorway, alongside the exit path but outside the exit path itself, as indicated in FIG. 3 and FIG. 4. Attendant seats, occupied by flight attendants during takeoff, landing and at other times are typically mounted inboard of the assist spaces near the exit paths. The attendant seats most typically fold upward to a stowed position when not occupied so as to remain clear of the exit path. The attendant seats in the stowed position are indicated in FIG. 3 and FIG. 4.

It would be desirable to provide improved aircraft space utilization by conforming an aircraft cabin enclosure wall immediately adjacent an aircraft emergency exit path to the spatial requirements for emergency exit paths prescribed by airworthiness authorities as well as to provide space inside the enclosure, such as to enable a mobility impaired passenger to transfer between an specialized onboard aisle wheelchair and a toilet in a lavatory, either unaided or with the aid of an assistant, or to allow for an installation of an amenity such as a seat, a sink, a waste bin, a paper towel dispenser, stowage, a display cabinet, or the like. The present invention meets these and other needs.

### SUMMARY OF THE INVENTION

Briefly and in general terms, the present invention provides for an enclosure for installation in a cabin interior of a passenger aircraft next to a passenger aisle and an emergency exit path of the passenger aircraft that provides for improved utilization of space in the passenger aircraft with an enclosure exterior wall immediately adjacent to the aircraft emergency exit path conforming to the spatial requirements for emergency exit paths prescribed by airworthiness authorities, providing space within the enclosure for amenities, such as for enabling a mobility impaired passenger to transfer between a wheelchair to a toilet in a lavatory, either unaided or with the aid of an assistant.

Accordingly, the present invention provides for an enclosure installed in a cabin interior of a passenger aircraft immediately adjacent to a passenger aisle of the passenger aircraft, immediately adjacent to an emergency exit path of the passenger aircraft, wherein the enclosure includes an exterior wall, such as a plurality of exterior walls including a first exterior wall adjacent to the passenger aisle and a second exterior wall joined to the first exterior wall and extending adjacent to and parallel to the emergency exit path. In a presently preferred aspect, the second exterior wall includes a first portion and a second portion, and the first portion is spaced apart from the emergency exit path a sufficient distance to define a space between the second exterior wall and the emergency exit path for a crew member to assist passengers exiting the airplane in the event of an emergency evacuation of the airplane. In another presently preferred aspect, the second portion of the second exterior wall is offset relative to the first portion of the second exterior wall in a direction toward the emergency exit path.

In another presently preferred aspect, the enclosure is a lavatory, and the second portion of the second exterior wall is offset relative the first portion of the second exterior wall in a direction toward the emergency exit path a sufficient distance to provide a space within the lavatory for the temporary placement of a wheelchair. In another presently preferred aspect, the second portion of the second exterior wall is offset relative the first portion of the second exterior wall in a direction toward the emergency exit path a sufficient distance to provide a space within the lavatory envelope for an installation of an amenity, such as a seat, a sink, a waste bin, a paper towel dispenser, stowage, a display cabinet, for example, or the like. In another presently preferred aspect, an attendant seat is provided immediately adjacent to the second exterior wall and adjacent to the emergency exit path.

These and other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a schematic diagram of a lavatory installed in a cabin interior of a passenger aircraft designed to enable a mobility impaired passenger to transfer between an specialized onboard aisle wheelchair and a toilet in the lavatory, and particularly for a 90 degree aided transfer, according to the present invention.

FIG. 2 is a schematic diagram of a lavatory installed in a cabin interior of a passenger aircraft designed to enable a mobility impaired passenger to transfer between an specialized onboard aisle wheelchair and a toilet in the lavatory, and particularly for a lateral transfer, according to the present invention.

FIG. 3 is a schematic diagram of a prior art lavatory installed in a cabin interior of a passenger aircraft designed to enable a mobility impaired passenger to transfer between an specialized onboard aisle wheelchair and a toilet in the lavatory.

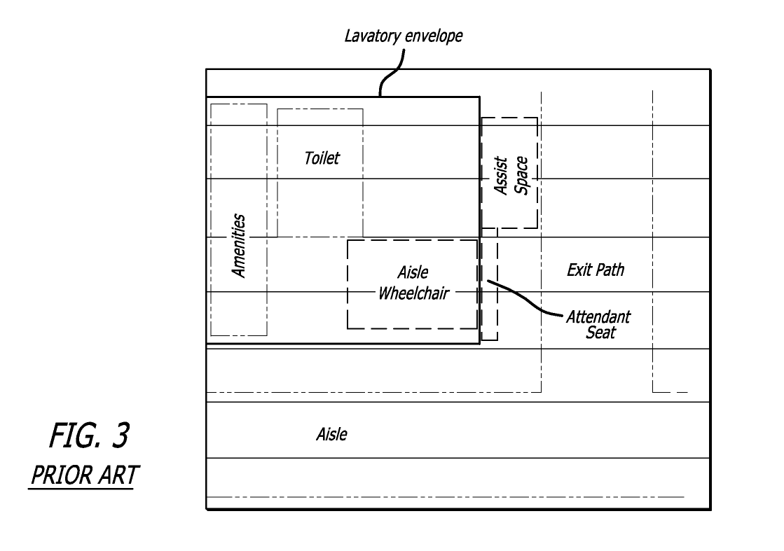

FIG. 4 is a schematic diagram of a prior art lavatory installed in a cabin interior of a passenger aircraft designed to enable a mobility impaired passenger to transfer between an specialized onboard aisle wheelchair and a toilet in the lavatory, and particularly for a lateral transfer.

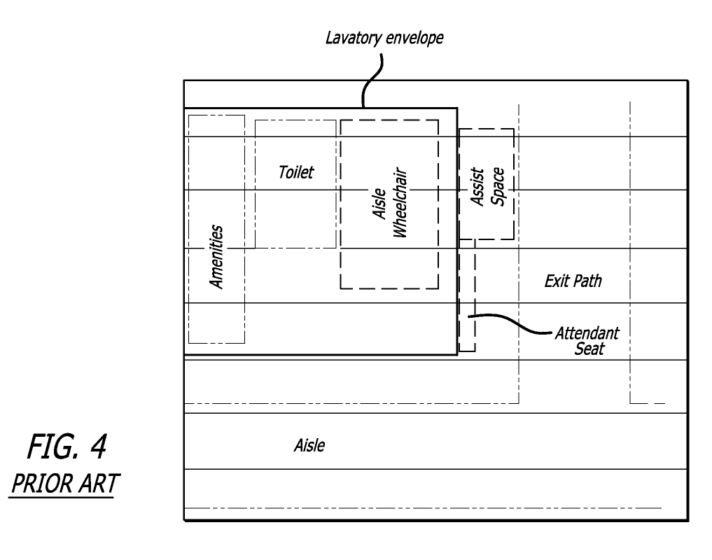

FIG. 5 is a schematic diagram of a lavatory installed in a cabin interior of a passenger aircraft designed with interior space for a changing seat, according to the present invention.

FIG. 6 is a schematic diagram of a lavatory installed in a cabin interior of a passenger aircraft designed with interior space for one or more amenities, according to the present invention.

### DETAILED DESCRIPTION OF THE PREFERRED EMBODIMENTS

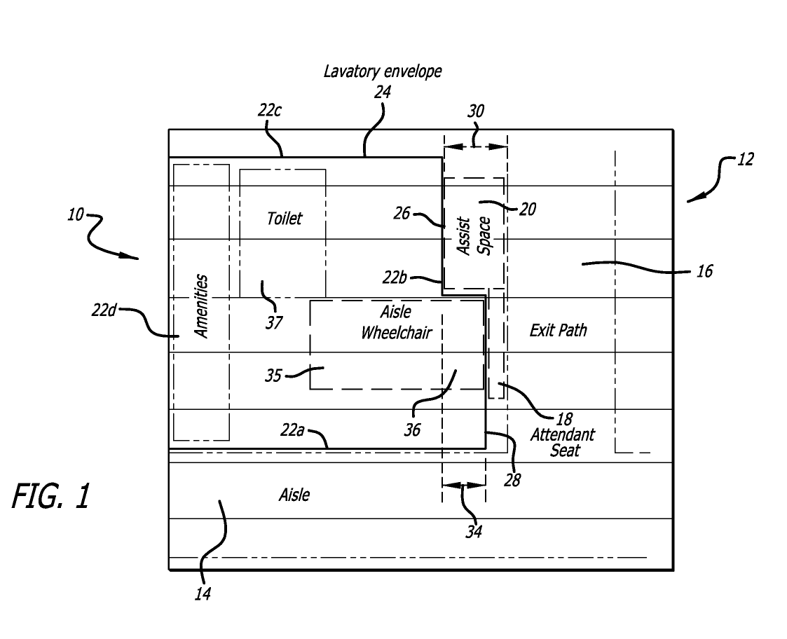

Referring to the drawings, which are provided by way of example, and not by way of limitation, the present invention provides for an enclosure 10, such as a lavatory, for example, installed in a cabin interior 12 of a passenger aircraft immediately adjacent to a passenger aisle 14 of the passenger aircraft, immediately adjacent to an emergency exit path 16 of the passenger aircraft, and immediately adjacent to an attendant seat 18 and an assist space 20 for a crew member to stand by an emergency exit door for the purpose assisting passengers during an emergency evacuation of an aircraft adjacent to the emergency exit path. Such an arrangement is illustrated in FIGS. 1, 2, 5 and 6. Such attendant seats, generally outlined in their stowed position in FIGS. 1, 2, 5 and 6, typically fold upward to a stowed position when not occupied so as to remain clear of the exit path.

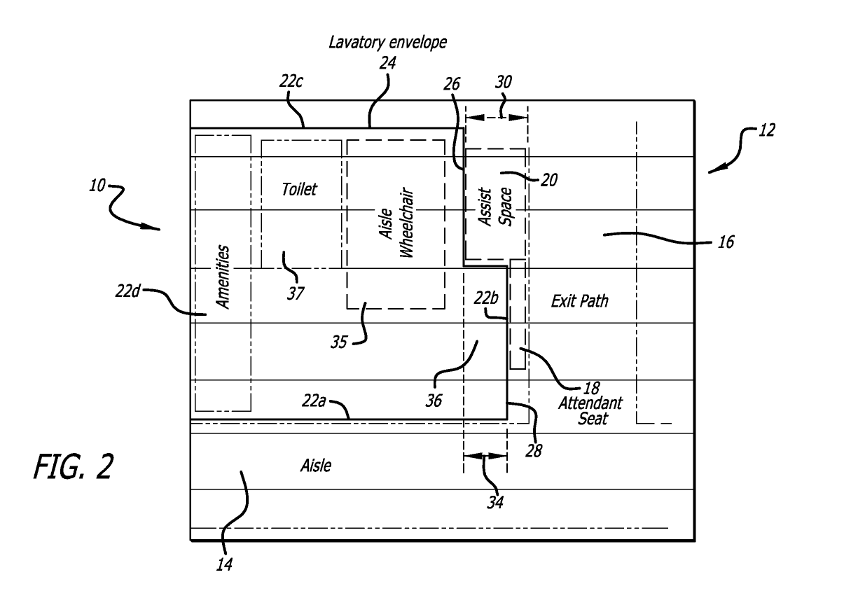

The enclosure includes one or more exterior enclosure walls, such as a plurality of exterior enclosure walls 22a, 22b, 22c, 22d forming an enclosure envelope 24, such as for a lavatory, for example. A first exterior wall 22a is typically positioned adjacent to the passenger aisle, and a second exterior wall 22b adjoining the first exterior wall and adjacent to and parallel to the emergency exit path. The second exterior wall preferably includes a first portion 26 and a second portion 28. The first portion is preferably spaced apart a distance 30 from the emergency exit path to provide the assist space, defined between the first portion of the second exterior wall and the emergency exit path, for a crew member to assist passengers exiting the airplane in the event of an emergency evacuation of the airplane. The second portion of the second exterior wall is also preferably offset relative to the first portion of the second exterior wall in a direction toward the emergency exit path a distance 34, preferably by a sufficient distance to provide a space 36 within the lavatory envelope for the positioning and temporary placement of a wheelchair, as is illustrated in FIGS. 1 and 2. A 90° transfer in which an aisle wheelchair 35 is positioned at a 90° angle to a lavatory toilet 37 and an assistant lifts the mobility-impaired passenger and rotates the passenger between the aisle wheelchair and the toilet is a preferred method for assisted transfers, and is illustrated in FIG. 1. A lateral transfer, in which a mobility-impaired passenger slides sideways between an aisle wheelchair and a lavatory toilet is preferred for an unassisted transfer when a mobility-impaired passenger prefers to make the transfer unaided and has the upper body strength to do so, is illustrated in FIG. 2. The offset of the second portion of the second exterior wall relative to the first portion of the second exterior wall allows the lavatory to be installed closer to the emergency exit path, leaving more room on the opposite side of the lavatory for passenger seating or other valuable installations.

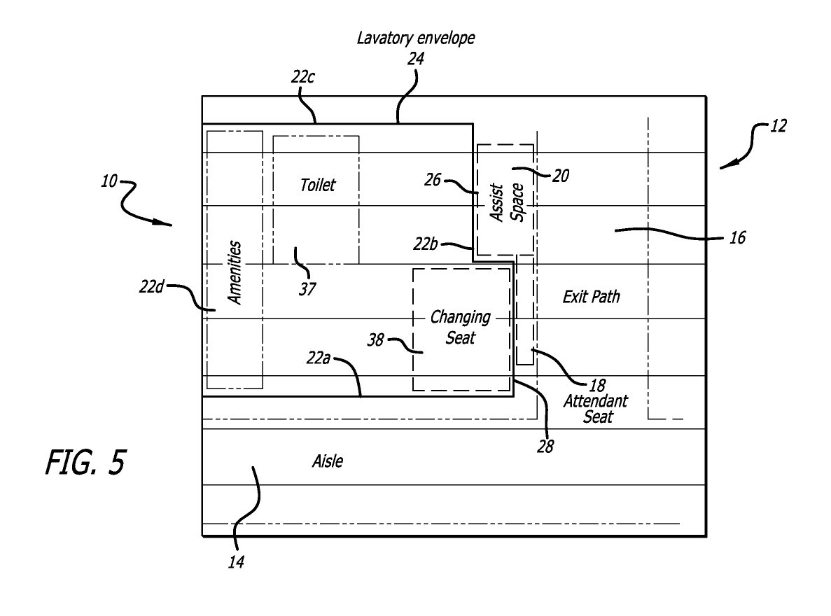

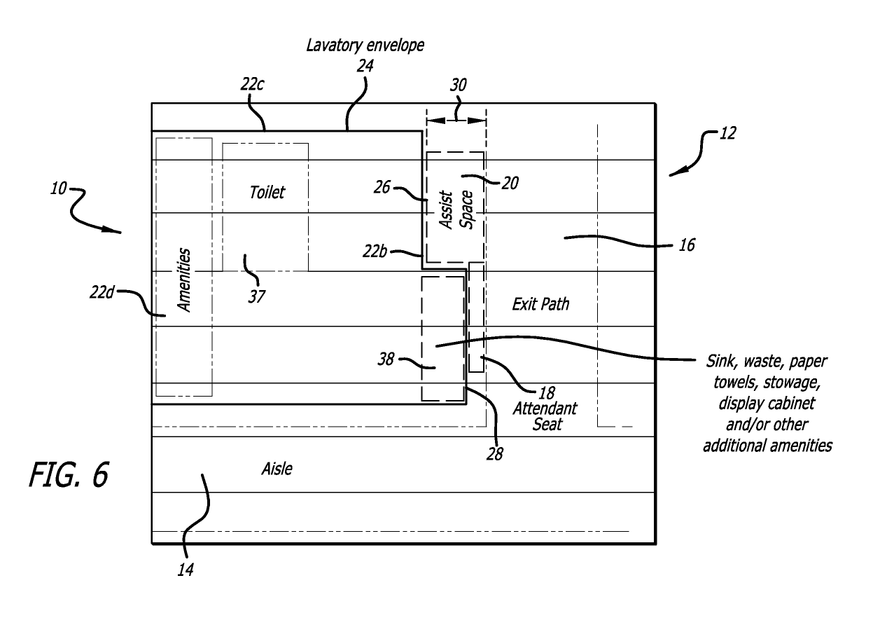

The second portion of the second exterior wall may, for example, be offset relative to the first portion of the second exterior wall in a direction toward the emergency exit path a sufficient distance to provide a space 38 for an installation of an amenity, such as a seat, a sink, a waste bin, a paper towel dispenser, stowage, a display cabinet, for example, or the like, as is illustrated in FIGS. 5 and 6.

The present invention exploits the interaction of the fact that stowed attendant seats are of lesser depth than the assist space, and the fact that the area inside the lavatory immediately adjacent the assist space outside the lavatory is unused in either transfer technique. The interaction is non-obvious to one of ordinary skill in the art of lavatory design because the regulatory requirements relating to exit path geometry are outside the area of expertise of those responsible for lavatory design. The opportunity to exploit the interaction is further obscured by the standard practice of using flat walls on lavatories, closets and other aircraft cabin structures to facilitate the positioning one of the structures immediately beside another of the structures. The standard practice fails to take advantage of the fact that only one wheelchair accessible lavatory is required by transportation authorities on each twin-aisle airplane and, as a result, the wheelchair accessible lavatory can be favored for a position immediately adjacent the emergency exit path.

It should be readily apparent that the wall design of the present invention can be readily adapted to closets or other structures installed immediately adjacent an aircraft emergency exit path. Accordingly, it will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. An enclosure for installation in a cabin interior of a passenger aircraft immediately adjacent to a passenger aisle of the passenger aircraft, immediately adjacent to an emergency exit path of the passenger aircraft, comprising:
a plurality of exterior enclosure walls forming an enclosure envelope, said plurality of exterior walls including a first exterior wall adjacent to the passenger aisle, and a second exterior wall adjoining said first exterior wall and adjacent to and parallel to the emergency exit path, said second exterior wall including a first portion and a second portion, said first portion being spaced apart from the emergency exit path to provide space for a crew member to assist passengers exiting the airplane in the event of an emergency evacuation of the airplane; and
wherein said second portion of said second exterior wall is offset relative to said first portion of said second exterior wall in a direction toward the emergency exit path.

2. The enclosure of claim 1, wherein said enclosure comprises a lavatory and said enclosure envelope comprises a lavatory envelope.

3. The enclosure of claim 1, wherein said second portion of said second exterior wall is offset relative to said first portion of said second exterior wall in a direction toward the emergency exit path a sufficient distance to provide a space within said lavatory envelope for the temporary placement of a wheelchair.

4. The enclosure of claim 1, wherein said second portion of said second exterior wall is offset relative to said first portion of said second exterior wall in a direction toward the emergency exit path a sufficient distance to provide a space within said lavatory envelope for an installation of an amenity.

5. The enclosure of claim 4, wherein said amenity comprises a seat.

6. The enclosure of claim 4, wherein said amenity comprises a sink.

7. The enclosure of claim 4, wherein said amenity comprises a waste bin.

8. The enclosure of claim 4, wherein said amenity comprises a paper towel dispenser.

9. The enclosure of claim 4, wherein said amenity comprises stowage.

10. The enclosure of claim 4, wherein said amenity comprises a display cabinet.

11. The enclosure of claim 1, further comprising an attendant seat adjacent to the emergency exit path and immediately adjacent to said second exterior wall.

12. A lavatory installed in a cabin interior of a passenger aircraft immediately adjacent to a passenger aisle of the passenger aircraft, immediately adjacent to an emergency exit path of the passenger aircraft, comprising:
a plurality of exterior lavatory walls forming an lavatory envelope, said plurality of exterior walls including a first exterior wall adjacent to the passenger aisle, and a second exterior wall adjoining said first exterior wall and adjacent to and parallel to the emergency exit path, said second exterior wall including a first portion and a second portion, said first portion being spaced apart from the emergency exit path to provide space for a crew member to assist passengers exiting the airplane in the event of an emergency evacuation of the airplane; and
wherein said second portion of said second exterior wall is offset relative to said first portion of said second exterior wall in a direction toward the emergency exit path a sufficient distance to provide a space within said lavatory envelope for the temporary placement of a wheelchair.

13. A lavatory installed in a cabin interior of a passenger aircraft immediately adjacent to a passenger aisle of the passenger aircraft, immediately adjacent to an emergency exit path of the passenger aircraft, comprising:
a plurality of exterior lavatory walls forming an lavatory envelope, said plurality of exterior walls including a first exterior wall adjacent to the passenger aisle, and a second exterior wall adjoining said first exterior wall and adjacent to and parallel to the emergency exit path, said second exterior wall including a first portion and a second portion, said first portion being spaced apart from the emergency exit path to provide space for a crew member to assist passengers exiting the airplane in the event of an emergency evacuation of the airplane; and
wherein said second portion of said second exterior wall is offset relative to said first portion of said second exterior wall in a direction toward the emergency exit path a sufficient distance to provide a space within said lavatory envelope for an installation of an amenity.

14. The lavatory of claim 13, wherein said amenity comprises a seat.

15. The lavatory of claim 13, wherein said amenity comprises a sink.

16. The lavatory of claim 13, wherein said amenity comprises a waste bin.

17. The lavatory of claim 13, wherein said amenity comprises a paper towel dispenser.

18. The lavatory of claim 13, wherein said amenity comprises stowage.

19. The lavatory of claim 13, wherein said amenity comprises a display cabinet.
